(19) United States
(12) Patent Application Publication
(10) Pub. No.: US 2014/0151297 A1
(43) Pub. Date: Jun. 5, 2014

(54) PORTABLE REVERSE OSMOSIS WATER PURIFICATION SYSTEM

(71) Applicant: Mar Cor Purification, Minneapolis, MN (US)

(72) Inventors: Clinton William Hulme, Pennsburg, PA (US); Sean Jay West, Seattle, WA (US); Kelly Dean Ross, Mansfield, TX (US)

(21) Appl. No.: 14/092,638

(22) Filed: Nov. 27, 2013

Related U.S. Application Data
(60) Provisional application No. 61/732,034, filed on Nov. 30, 2012.

(51) Int. Cl. B01D 65/02; C02F 1/44

(52) U.S. Cl. CPC B01D 65/02; C02F 1/441; B01D 65/022
USPC 210/636

(57) ABSTRACT

In a reverse osmosis fluid purification system, an input fluid is received at an input of the purification system, and a fluid purification run cycle is performed on the input fluid. The fluid purification cycle includes pumping the input fluid through a membrane with a pump at a first pressure and first flow rate to generate product fluid and waste fluid. The product fluid is provided to an external system and the waste fluid is provided to a drain port. The membrane is then rinsed after performing the fluid purification run cycle by providing the input fluid to the pump and pumping the input fluid through the membrane at a second pressure less than the first pressure and a second flow rate greater than the first flow rate for a predetermined period of time.

### CROSS-REFERENCE TO RELATED APPLICATIONS

This application claims priority to U.S. Provisional Application No. 61/732,034, filed on Nov. 30, 2012, and entitled “Portable Reverse Osmosis Water Purification System,” the disclosure of which is incorporated by reference.

### TECHNICAL FIELD

The present disclosure relates to water purification systems. More specifically, the present disclosure relates to a portable reverse osmosis water purification system.

### BACKGROUND

Reverse osmosis is a filtration method that removes many types of large molecules and ions from solutions by applying pressure to the solution when it is on one side of a selective membrane. More formally, reverse osmosis is the process of forcing a solvent from a region of high solute concentration through a semipermeable membrane to a region of low solute concentration by applying a pressure in excess of the osmotic pressure. The result is that the solute is retained on the pressurized side of the membrane and the pure solvent is allowed to pass to the other side. The membrane is selective in that large molecules or ions are not allowed through the pores in the membrane, but allows smaller components of the solution (such as the solvent) to pass freely. Reverse osmosis filtration has various applications, including drinking water purification, wastewater purification, food industry uses (e.g., for concentrating food liquid), and health care uses (e.g., electrodialysis systems).

### SUMMARY

In one aspect of the present disclosure, a method for operating a reverse osmosis fluid purification system includes receiving an input fluid at an input of the purification system, and performing a fluid purification run cycle on the input fluid. The fluid purification cycle includes pumping the input fluid through a membrane with a pump at a first pressure and first flow rate to generate product fluid and waste fluid. The product fluid is provided to an external system and the waste fluid is provided to a drain port. The membrane is then rinsed after performing the fluid purification run cycle by providing the input fluid to the pump and pumping the input fluid through the membrane at a second pressure less than the first pressure and a second flow rate greater than the first flow rate for a predetermined period of time.

In another aspect, a method for operating a reverse osmosis fluid purification system includes initiating a disinfection cycle and draining an internal tank to a minimum level. Input fluid is pumped from a fluid source through a membrane to generate product fluid and waste fluid. The flow of the input fluid from the fluid source is then terminated. The product fluid is directed to the internal tank until the internal tank is filled to a maximum level. The flow of the input fluid from the fluid source is then terminated. An amount of the product fluid is pumped from the internal tank through the membrane until the product fluid in the internal tank is at an intermediate level between the minimum and maximum levels. The amount of product fluid pumped from the internal tank forces fluid residing in the fluid path from the pump through the membrane and to the drain port.

In a further aspect, a method for operating a reverse osmosis fluid purification system includes disconnecting the fluid purification system from a fluid source and waste port, transporting the fluid purification system to a storage location, and connecting the fluid purification system to an electrical source at the storage location. A storage heat cycling mode is then performed in which the product fluid in the internal tank and system is repeatedly heated and circulated through portions the reverse osmosis fluid purification system.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a schematic view of an embodiment of a reverse osmosis water purification system illustrating water flow during a water purification cycle with varying fluid pressures.

FIG. 2 is a schematic view of the reverse osmosis water purification system illustrating water flow during a shut down flush after the water purification cycle.

FIG. 3 is a schematic view of the reverse osmosis water purification system illustrating water flow during steps of a pure water storage and purge of the reverse osmosis membrane.

FIG. 4 is a schematic view of the reverse osmosis water purification system illustrating water flow during a recurring heat mode after disconnecting the system from water feed and waste lines.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

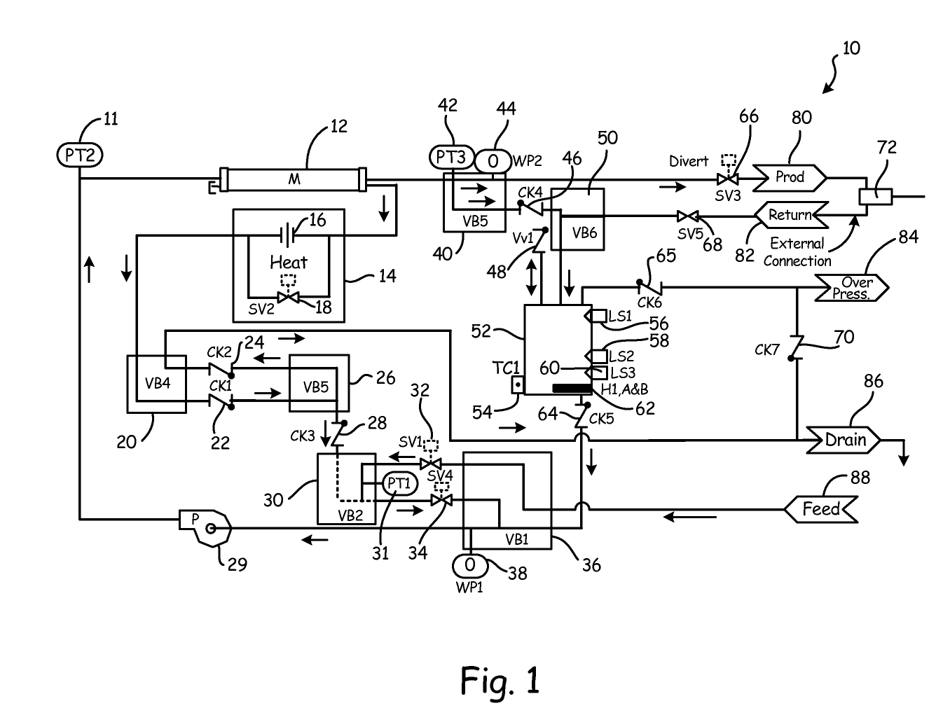

FIG. 1 is a schematic view of an embodiment of a reverse osmosis water purification system 10 according to the present disclosure. The system 10 purifies a given feed water (by way of reverse osmosis) for use in various applications, such as hemodialysis. The system 10 possesses monitoring for feed water pressure, feed water quality, feed water temperature, pump outlet pressure, product water pressure, product water temperature, product water quality, and membrane performance (percent rejection). A pump provides the pressure required to push water through the reverse osmosis membrane and against a fixed orifice. Fluid controls provide a means of managing flow rates and pressures.

The system 10 includes a pressure sensor 11, a reverse osmosis membrane 12, a valve body 14 including an orifice 16 and solenoid valve 18, a valve body 20, check valves 22 and 24, a valve body 26, a check valve 28, a pump 29, a valve body 30, a pressure sensor 31, solenoid valves 32 and 34, a valve body 36, a quality sensor 38, a valve body 40, a pressure sensor 42, a quality sensor 44, a check valve 46, a tank vent valve 48, a valve body 50, an internal tank 52, a thermal switch 54, level sensors 56, 58, and 60, a heater 62, check valves 64 and 65, solenoid valves 66 and 68, a check valve 70, and an external connection 72. The system 10 also includes a product water output 80, a return input 82, an overpressure output 84, a drain output 86, and a feed water input 88. The valve bodies 14, 20, 26, 30, 36, 40, and 50 are configured to control flow rates and pressures in the system 10. The operation of the system 10 is controlled by a controller (not shown) that is programmed to operate the components of the system 10 to provide various functionalities (e.g., water purification, sanitization, etc.).

The membrane 12 is connected to the pump 29 at the input of the membrane 12. The pump 29 controls the fluid pressure through the system 10. The pump 29 controls water pressure input to the membrane 12. In some embodiments, the pump 29 includes a variable frequency drive. In some embodiments, the pump 29 has a pump pressure of about 160-200 pounds per square inch (psi) (1.10-1.24 MPa). The pressure sensor 11 measures the pressure of the fluid provided to the input of the membrane 12. In some embodiments, the output of the pressure sensor 11 is used to control the operation of the pump 29. For example, the pressure sensor 11 may be configured to shut down the system 10 if the sensor 11 detects an overpressure condition.

In some embodiments, the membrane 12 is a single membrane comprised of a polymeric material. The membrane 12 may include a dense layer in a polymer matrix, such as the skin of an asymmetric membrane or an interfacially polymerized layer within a thin-film-composite membrane, where the separation of the product water from the waste water occurs. The membrane 12 may have a variety of configurations including, for example, spiral wound or hollow fiber configurations.

The outputs of the membrane 12 are connected to the valve body 14 (via a waste output) and valve body 40 (via a product output). The solenoid valve 18 of the valve body 14 remains closed during normal operation, such that drain water from the output of the membrane 12 passes through the orifice 16. During a heat sanitization process, the solenoid valve 18 opens to help maintain the system 10 at a predetermined pressure during the sanitization process.

The output of the valve body 14 is provided to the check valve 22 via the valve body 20. The check valve 22 is controlled in some embodiments to reduce flow and maintain a minimum pressure in the fluid path. The output of the check valve 22 is in fluid communication with the check valve 24 via the valve body 26. In some embodiments, the check valve 24 is controlled in some embodiments to maintain a minimum pressure sufficient to block flow to the drain output 86. The output of the check valve 24 is connected to the drain output 86 via the valve body 20. The drain output 86 may be connected to a receptacle or other system for proper disposal of the drain fluid.

An output of the valve body 26 is also connected to the inlet of the check valve 28, which located between the feed water fluid path from the input 88 and the fluid path of the drain output 86 and, in some embodiments, is configured to allow waste fluid flow to supply the pump 29 with water, such as during low pressure operation conditions. The output of the check valve 28 is connected to the solenoid valve 34 via the valve body 30. During a normal water purification cycle, as illustrated in FIG. 1, the solenoid valve 34 cycles with depending on the level of water in the tank 52. During heating and chemical sanitization modes of operation, described in more detail below, the solenoid valve 34 operates to isolate the pump 29.

The solenoid valve 32 is connected between the feed water input 88 and the valve body 30. The feed water input 88 may be connected to any pre-filtered fluid source that provides untreated water to the system 10 for purification. The solenoid valve 32 is configured to control the flow of feed water into the system 10 from the feed water input 88. The pressure sensor 31 monitors the fluid pressure in valve body 30 and in some embodiments is configured to shut down the system 10 if the feed water from the feed water input 88 falls below a threshold pressure.

The product water output of the membrane 12 is connected to the solenoid valve 66 via the valve body 40. The solenoid valve 66 is configured to divert product water away from the product water output 80 during certain operations of the system 10. For example, during system run startup flush, the solenoid valve 66 is closed until the system 10 is producing product water below a water quality set point (e.g., as measured in μS). During heat sanitization and chemical modes, the solenoid valve 66 cycles to direct fluid throughout the system 10 to ensure proper cleaning and disinfection. During normal operation, illustrated in FIG. 1, the solenoid valve 66 is open to allow product water to be provided to the external connection 72 via the product water output 80. The external connection 72 may be coupled to a system that uses the product water, such as a hemodialysis machine.

The pressure sensor 43 is connected between the membrane 12 and the solenoid valve 66 and is configured to monitor the pressure of the product water provided from the membrane 12. If an overpressure condition is detected by the pressure sensor 43, the system 10 may respond to reduce the pressure and may be shut down.

The quality sensor 44 monitors the quality and temperature of the product water after it exits the membrane 12. The product water quality measured by the quality sensor 44 can be reviewed (e.g., on a screen associated with the system 10) during normal operation. An additional display for review is a system calculated percent rejection comparison between the unpurified water flowing in valve body 36 and the purified product water flowing in valve body 40.

The input of the check valve 46 is connected between the output of the membrane 12 via the valve body 40, and the output of the check valve 46 is connected to the input of the internal tank 52 via the valve body 50. The check valve 46 is controllable to prevent backflow of water in the internal tank 52 into the product water provided to the product water output 80. The check valve 46 also provides a pressure regulation for the line from the membrane 12 to the product water output 80.

The solenoid valve 68 provides fluid flow resistance during normal operation to the unused product water returning from the external connection 72. In some embodiments, the solenoid valve 68 provides a backpressure to maintain the product water at a pressure of approximately 35 psi (0.241 MPa). During heating operation, the solenoid valve 68 is opened and provides full free flow.

The return input 82 provides an input to return product fluid via the external connection 72 to the system 10. For example, in a hemodialysis application, the return input 82 allows fluid not used during dialysis to be returned to the system 10 for re-purification. The return input 82 may also be used to return fluid to the system 10 during heat and chemical cleaning modes of the system 10.

The internal tank 52 receives water from the check valve 46 and/or the return input 82. The vent valve 48 is configured to allow airflow to and from the tank 52, but not water from the tank 52. The temperature of the water in the internal tank 52 is monitored by the thermal switch 54. If the water in the tank 52 exceeds a fixed threshold temperature, the thermal switch 54 provides an indication to the system controller and also removes the control signal from the heater 62 power supply circuit. The level of the fluid in the internal tank 52 is measured by the level sensors 56, 58, and 60. The level sensor 56 is triggered when water in the tank 52 is at or above a maximum water level, the level sensor 58 is triggered when water in the tank 52 is at or below an intermediate water level, and the level sensor 60 is triggered when the water in the tank 52 is at or below a minimum water level. The heater 62 is operable to heat the water in the tank 52. The check valve 64 is at the outlet of the tank 52 and prevents pump 29 feed water from being fed back into the tank 52.

The check valve 65 is connected between the tank 52 and the overpressure output 84 and is configured to prevent the tank 52 from over-pressurizing. The check valve 70 is connected between the drain output 86 and the overpressure output 84 and is configured to relieve pressure in the drain line when the drain output 86 is not connected or not functional.

FIG. 1 illustrates the water flow during a water purification cycle, in conjunction with water quality monitoring and run flush activities, in which the system 10 purifies feed water supplied at the feed input 88 and provides product water at the external connection 72 via the product water output 80. In this process, the solenoid valves 18 and 68 and check valves 65 and 70 are closed, while the solenoid valves 32, 34, and 66 and check valves 22, and 24 are open. In some embodiments with lower feed water pressure at input 88, check valves 28 and 64 open and allow water flow to support the supply to pump 29. The water from the feed water input 88 is fed through solenoids 32 and 34 via valve bodies 36 and 30 to the pump 29 and forced through the membrane 12 at a pressure controlled using pressure sensor 11 and the pump 29. In some embodiments, the pressure of the feed water at the input side of the membrane 12 is about 160-180 psi. The product water from the membrane 12 is then provided to the product water output 80, and the non-recirculating waste or drain water flows through the check valves 22 and 24 to the drain output 86.

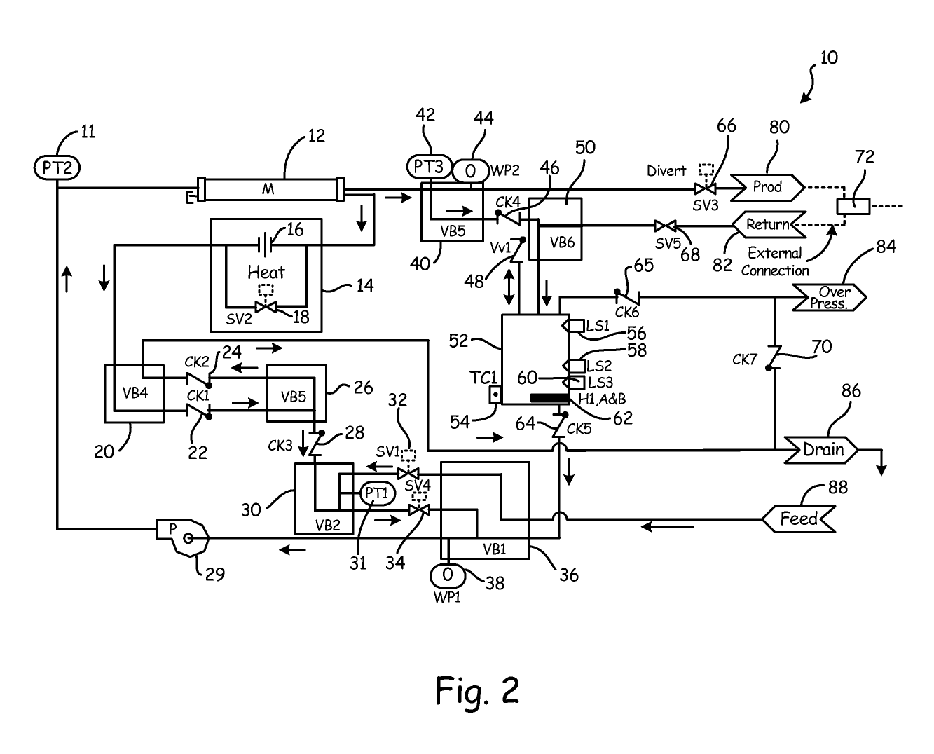

FIG. 2 is a schematic view of the reverse osmosis water purification system 10 illustrating water flow during a shut down flush after the water purification cycle according to an embodiment of the present disclosure. During the shutdown flush, the membrane 12 is rinsed to clear the membrane surface of high concentration feed water. In some embodiments, the shut down flush is performed automatically and cannot be overridden by the operator of the system 10.

In the shut down flush mode, the solenoid valves 18, 32, and 34 are open, while the solenoid valves 65, 66 , 68, and 70 are closed. Additionally, the check valves 22, 24, 28, 46, and 64 are open. Thus, the flow path from the membrane to the product water output 80 is closed to divert the product water to the tank 52. The speed of the pump 29 is controlled to supply the feed water applied by the pump 29 at a pressure less than the pressure during the normal water purification cycle. This allows low pressure, high flow rate water to rush across the outer surface of the membrane 12. The flushing water flows through the membrane 12, out the waste output of the membrane, to the drain output 88. In some embodiments, the shut down flush is performed on the membrane 12 for a programmed period of time. For example, in one implementation, the shut down flush is performed for at least about one minute.

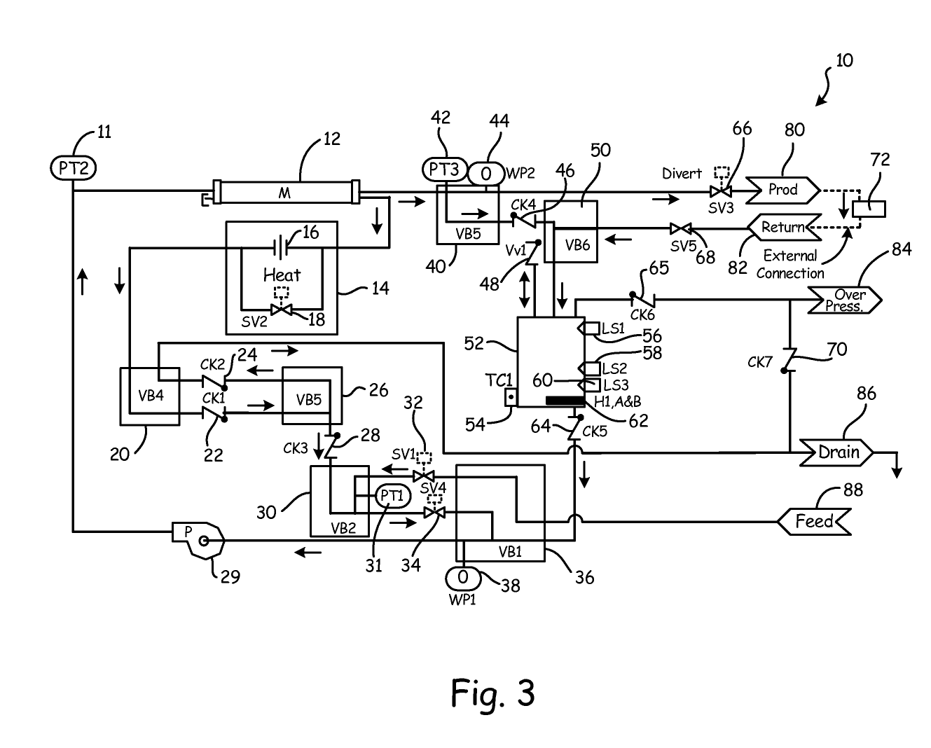

FIG. 3 is a schematic view of the reverse osmosis water purification system 10 illustrating various water flow paths during a pure water purge, heat sanitization, and or chemical induction of the reverse osmosis water purification system 10, according to embodiments of the present disclosure. Specifically during the pure water purge step, a contained amount of pure product water is produced and captured. A portion of this captured pure water is then used to force or purge out the high concentration water from the membrane 12 and the waste fluid flow paths to the drain port 86. The remaining volume of pure water is used for recirculation during heating or chemical induction modes of operation. Specifically, in the chemical mode of operation, a container of chemical sterilant is connected between external connection 72 and the product output 80 for chemical induction by the system 10. In this induction process the solenoid valves 34, 66 and 68 are opened, and the solenoid valves 18 and 32 are closed. Additionally, the check valves 22, 28, 46 and 64 are opened, and the check valves 24, 65, and 70 are closed. This arrangement allows chemical to be circulated through the system 10. Specifically in the heat recirculation mode of operation, the solenoid valves 66, 68 and 34 are opened, and the solenoid valves 18 and 32 are closed. Additionally, the check valves 64, 28, 22 and 46 are opened, and the check valves 24, 65, and 70 are closed. In some embodiments, the chemical is heated to provide increase the efficacy of the sterilant (e.g., at least about 70° F.).

Upon selecting the chemical or heat mode of operation, standing water in the internal tank 52 is provided to the drain output 86 until the level of water in the tank 52 is at a minimum level. For example, the internal tank 52 will be drained until the level sensor 60 no longer senses water in the tank 52. The solenoid valves 32 and 34 are then opened to allow the feed water from the feed water input 88 to be provided to the pump 29, and the system 10 is operated in a normal water purification mode as described previously, but the product water is diverted to the internal tank 52 to refill the tank 52 to a maximum level. For example, product water will be diverted into the internal tank 52 until the level sensor 56 senses water. The solenoid valve 32 is then closed, and the system 10 is operated to again consume the water in the tank 52 down to an intermediate level between the maximum level and the minimum level. For example, product water in the tank 52 is provided to the pump 29 to be forced through the membrane 12 until the water in the tank 52 drops until the level sensor 58 no longer senses water in the tank 52. In some embodiments, the amount of water consumed in from the tank 52 to reach the intermediate level is sufficient to displace the water in the flow path between the tank 52 and the drain output 86.

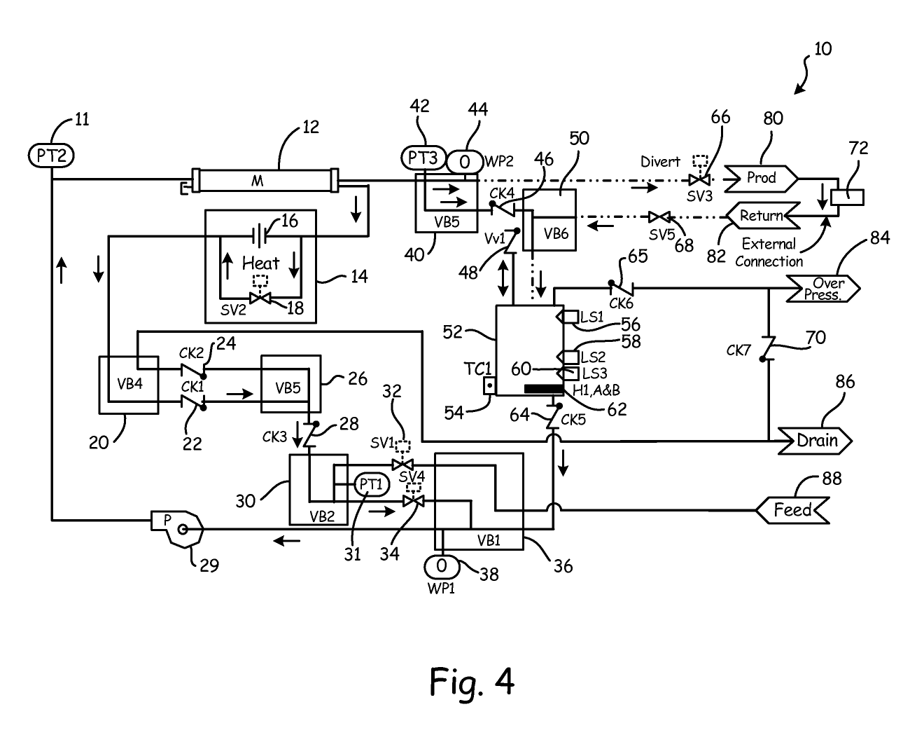

FIG. 4 is a fluid flow schematic view of the reverse osmosis water purification system 10 illustrating water flow specifically during a recurring heat mode after the purge step and after disconnecting tubing lines from water feed 88 and waste line 86, according to an embodiment of the present disclosure. When the water purification system 10 is going to be stored for an extended period of time, it is important to maintain the system 10 in a sanitized state such that the system 10 is ready for use when needed. In the recurring heat mode, the solenoid valves 68 and 34 are opened, solenoid valve 18 is closed, and solenoid valve 66 is alternatingly opened and closed in predetermined intervals to allow fluid flow and even heating in the flow paths between membrane 12 product output and system 10 product output 80, past the product supply port 72, and on to return port 82. And alternately the product divert path through check valve 48 and valve body 50, with both flows returning to tank 52 for re-heating. Additionally check valve 48 allows the tank 52 to breath or exchange air as needed during the heating process.

The operator of the system 10 can initiate a recurring heat mode when the system 10 is ready to be transported to a storage location. In some embodiments, when the recurring heat mode is initiated, the system 10 may execute a pure water purging step as described above with regard to FIG. 3. This puts product water into the tank 52 for the recurring heat mode. A display (not shown) associated with the system 10 may then provide the operator with instructions for relocating the system 10 to a storage location to initiate the recurring heat mode. The operator disconnects the feed water line from the feed water input 88 and the drain connection from the drain output 86, and the system 10 from an electrical source that powers the system controller and other system components. The system 10 is then transported to the storage location and re-connected to an electrical source. The operator can then complete the steps to cause the system 10 to operate in the recurring heat mode while being stored with no ties to feed water or waste connections.

When started, the recurring heat mode begins by operating pump 29 and the heater 62 to circulate and heat the water in the system 10 to a predetermined temperature. In some embodiments, the predetermined temperature is at least about 176° F. When the system 10 reaches the predetermined temperature, the system 10 cycles the heater 62 to maintain the water at the predetermined temperature for a predetermined period of time. In some embodiments, this predetermined period of time is at least about 30 minutes. After this time, the system 10 allows the water to cool by halting the heating process and continuing to circulate the water through the system 10. The system may then initiate another heat cycle to heat the water to the predetermined temperature, regardless of the standing system temperature. The system 10 may be programmed by the operator to set the frequency at which the recurring heat cycle is run. In some embodiments, in the event of a failure of the power source while the system 10 is in the recurring heat mode, or resting, waiting for the next recurring heat mode trigger, the system 10 will automatically re-initiate the recurring heat mode upon the return of power, starting with circulation and heating of the water in the system 10.

When the system 10 is to be used, the operator can cancel or abort the recurring heat mode. When canceled, the system 10 will exit from the recurring heat mode. If the water in the system 10 is above a programmed temperature (e.g., 105° F.) when the recurring heat mode is canceled, the system 10 enters a cool down mode until the water in the system is below the programmed temperature. The system 10 can then be run by the operator for a period of time (e.g., ten minutes), after which time the system 10 is ready for dialysis use.

Attached to this application as Appendix A is a document entitled “Mar Cor Purification, Millenium HX Reverse Osmosis Unit, Operation and Maintenance Manual,” which describes aspects of the system 10 and processes described herein, as well as the user interface, housing, and other features of the system 10. The information in Appendix A supplements the information discussed herein.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

1. A method for operating a reverse osmosis fluid purification system, the method comprising:
receiving an input fluid at an input of the purification system;
performing a fluid purification run cycle on the input fluid, the fluid purification cycle comprising pumping the input fluid through a membrane with a pump at a first pressure and first flow rate to generate product fluid and waste fluid, wherein the product fluid is provided to an external system and the waste fluid is provided to a drain port; and
rinsing the membrane after performing the fluid purification run cycle, wherein rinsing the membrane comprises:
providing the input fluid to the pump; and
pumping the input fluid through the membrane at a second pressure less than the first pressure and a second flow rate greater than the first flow rate for a predetermined period of time.

2. The method of claim 1, wherein the predetermined period of time is at least one minute.

3. The method of claim 1, and further comprising:
providing the fluid pumped through the membrane in the rinsing step to a drain port.

4. The method of claim 1, wherein the rinsing step occurs automatically after the performing step and cannot be overridden by an operator of the reverse osmosis fluid purification system.

5. A method for operating a reverse osmosis fluid purification system, the method comprising:
initiating a disinfection cycle;
draining an internal tank to a minimum level;
pumping input fluid from a fluid source through a membrane to generate product fluid and waste fluid, wherein the waste fluid is provided to a drain port;
terminating flow of the input fluid from the fluid source;
directing the product fluid to the internal tank until the internal tank is filled to a maximum level; and
pumping an amount of the product fluid from the internal tank through the membrane until the product fluid in the internal tank is at an intermediate level between the minimum and maximum levels, wherein the amount of product fluid pumped from the internal tank forces fluid between the internal tank and the membrane through to the drain port.

6. The method of claim 5, and further comprising:
heating the product fluid to a disinfecting temperature; and
holding the product fluid at the disinfecting temperature for a predetermined period of time.

7. The method of claim 6, wherein the heating step comprises heating the product fluid to at least about 80° C.

8. The method of claim 6, wherein the predetermined period of time is at least about 30 minutes.

9. The method of claim 5, and further comprising:
connecting a chemical sterilant source to a product return line in fluid communication with the internal tank; and
circulating chemical sterilant from the chemical sterilant source through the reverse osmosis fluid purification system for a predetermined period of time.

10. The method of claim 9, wherein the predetermined period of time is at least about one hour.

11. The method of claim 9, and further comprising:
flushing the chemical sterilant from the reverse osmosis fluid purification system, wherein flushing comprises repeatedly pumping input fluid from the fluid source through the membrane for a plurality of cycles.

12. The method of claim 11, wherein the plurality of cycles comprises at least 30 cycles.

13. The method of claim 5, and further comprising:
terminating connection of the reverse osmosis fluid purification system from the fluid source and the waste drain; and
initiating a storage heat cycling mode in which the product fluid in the internal tank is repeatedly heated and circulated through the reverse osmosis fluid purification system.

14. The method of claim 13, wherein the product fluid in the internal tank is repeatedly heated and circulated at a user-selected frequency.

15. A method for operating a reverse osmosis fluid purification system, the method comprising:
disconnecting the fluid purification system from a fluid source and waste port;
transporting the fluid purification system to a storage location;
connecting the fluid purification system to an electrical source at the storage location; and
performing a storage heat cycling mode in which the product fluid in the internal tank is repeatedly heated and circulated through the reverse osmosis fluid purification system.

16. The method of claim 15, wherein the product fluid in the internal tank is heated to a temperature of at least about 80° C.

17. The method of claim 15, wherein the product fluid in the internal tank is repeatedly heated and circulated at a user-selected frequency.

18. The method of claim 15, wherein the reverse osmosis fluid purification system automatically re-initiates the storage heat cycling mode when connection to the electrical source is lost and subsequently re-established.

19. The method of claim 15, and further comprising:
terminating the storage heat cycling mode;
connecting the reverse osmosis fluid purification system to the fluid source and waste port; and
operating the reverse osmosis fluid purification system according to the method of claim 1.

20. The method of claim 15, wherein prior to the disconnecting step, the method further comprises:
purging the membrane with product fluid according to the method of claim 4.
